(19) United States
(12) Patent Application Publication
(10) Pub. No.: US 2018/0230351 A1
(43) Pub. Date: Aug. 16, 2018

(54) NEW FORMULATIONS OF NITRATE SALTS FOR USE AS FLUID FOR THE STORAGE AND TRANSFER OF HEAT

(71) Applicant: QUIMICA DEL ESTRONCIO, S.A., Cartagena (Murcia) (ES)

(72) Inventors: Francisco Lorman Martinez, Cartagena (ES); Francisca Galindo Paniagua, Madrid (ES); Maria Del Pilar Pena Castro, Cantoblanco Madrid (ES); Luis Contreras Sanchez, Cantoblanco Madrid (ES)

(73) Assignee: QUIMICA DEL ESTRONCIO, S.A., Cartagena (ES)

(21) Appl. No.: 15/758,150

(22) PCT Filed: Mar. 16, 2015
(86) PCT No.: PCT/ES15/70180

§ 371 Date: Mar. 7, 2018

(30) Foreign Application Priority Data
Jan. 15, 2015 (ES) P201530038

(51) Int. Cl. C09K 5/12

(52) U.S. Cl. CPC C09K 5/12

(57) ABSTRACT

The invention relates to the innovative formulation of mixtures of nitrate salts, the composition of which is fundamentally based on strontium nitrate and other alkaline metal nitrates. These salts, according to the invention, produce an eutectic mixture with a meting point lower than 210° C., in a ternary formulation and the decomposition thereof occurring at a temperature greater than 00° C. In addition, other non-eutectic compositions are provided for the purpose of adapting their melting point to the different applications if considered necessary. Furthermore, this ternary formulation is more competitive than the existing formulations from an economic point of view. This formulation of salts has a direct application as a heat storage fluid, as well as a vehicle for heat transfer, being suitable for heat accumulation and transmission systems in thermosolar centres, as well as in any other application requiring temporary storage of thermal energy and the subsequent transfer thereof. The main provision of this invention is a fluid that can maintain its liquid state for a more prolonged period and at a temperature lower than the existing formulations, without the need to provide external heat and ensuring the stability of same at more elevated temperatures.

### STATEMENT REGARDING FEDERALLY SPONSORED RESEARCH OR DEVELOPMENT

Not applicable.

### BACKGROUND

### Field of the Disclosure

The present invention is framed within the Renewable Energies Sector, in particular in the field of Thermal Energy. This managed with an innovative formula mix of nitrate salts, whose composition is based primarily on Strontium Nitrate and two other alkali metal nitrates. Likewise, its use is contemplated in the storage and transfer or transport of thermal energy.

### Background of the Disclosure

One of the important challenges for the development of renewable energies is its storage and this is one of the main problems with the production of Solar energy in thermosolar plants. It is necessary to transport the thermal energy that is produced and store it for later use.

For transport, the use of thermal and synthetic oils is quite widespread, due fundamentally to their wide range of working temperatures, normally approximately between 12° C. and 390° C., as they do not freeze, boil or decompose. Nevertheless, these fluids are not suitable for the storage of heat, due fundamentally to their low density properties, low calorific capacity high viscosity and high cost.

So far the most used system, mainly in solar thermal power plants with heat storage, is a fluid consisting of binary salt fused nitrates. These salt mixtures have several advantages as storage fluids, such as their high density, high calorific capacity, high decomposition temperature (generally higher than 500° C.) and their competitive cost. Furthermore their physicochemical properties make them suitable for use as heat storage fluids in large tanks.

However, the main problem faced by thermal energy storage with molten salts as thermal fluid, is the risk of the salt's solidification, so it's necessary to keep the melt perfectly insulated and with the contribution of external heat in case the temperature decreases to values close to the point of fusion. On the other hand, although the decomposition temperatures are generally much higher than those of thermal oils, it is sought to work at the maximum temperature that allows the intermediary fluid (thermal oil or others such as the salts themselves) to increase the effectiveness of the Rankine cycle when delivering the stored energy. The stability of these salts at high temperatures is of the utmost importance, since decompositions in products must be avoided that could cause corrosion or that could be toxic.

The nitrate salts of alkali metals and alkaline earth are the most suitable for their application as thermal storage because of their good physicochemical properties and their stability at high temperatures. They form melted mixtures that are homogeneous and feature eutectic mixtures that have fusion points which are lower than the fusion points of each one of the pure salts.

The most used mixture of nitrates that is currently used is a binary mixture of Sodium Nitrate and Potassium Nitrate (60%: 40% by weight) called Solar Salt (SS), for commercial reasons, using a formula in a different proportion from that of the eutectic one. The cost of KNO₃ is greater than that of NaNO₃ so a mix with greater proportion of NaNO₃ is cheaper although its point of fusion is higher. In FIG. 1, you are shown the KNO₃—NaNO₃ balance diagram, in this figure it can be seen that it's about a simple eutectic system, the eutectic composition for this mixture of salts, is situated around 54% KNO₃ and 46% NaNO₃ in moles. This salt's point of fusion is 222±5° C. However, in the SS, the formation of crystals during cooling (temperature of liquids) starts at a higher temperature, so in practice, the storages maintain a temperature which is higher than 250° C. (usually 280° C.) to avoid the solidification of the melt.

This high temperature of fusion makes it so that these molten salts are not able to be used directly as a thermal transport fluid and that the storage system is more energetically expensive, further shrinking the number of hours of operation without heat input.

Another factor to be considered for its current uses is for its application as a heat accumulator, is its danger of corrosivity. This is presented mainly by the presence of impurities and the possible decompositions of the nitrates in nitrous gases at high temperatures. An ideal mix, should have a composition which is completely stable in the working temperature range, so that there are no impurities nor compounds capable of producing corrosion in the working equipment.

### SUMMARY

Embodiments of the disclosure pertain to a composition having a ternary mixture of nitrate salts being one of the components Strontium Nitrate and the other two, alkali nitrate salts.

There may be at least one of the alkali nitrate salts present in the composition is selected from Sodium Nitrate and Potassium Nitrate.

The composition may have Strontium Nitrate, Sodium Nitrate and Potassium Nitrate.

The composition may be eutectic.

In aspects, the Strontium Nitrate may be from 5 to 50% and the sum of alkali nitrate salts from 50 to 95% by weight of the composition.

In aspects, percentages by weight of Strontium Nitrate, Potassium Nitrate and Sodium Nitrate, may be situated at 10% -53% -37% by weight.

The composition may be used in or useful for the storage and transfer of thermal energy.

In aspects, the thermal energy may be thermal solar.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1 shows Binary Eutectic System KNO₃—NaNO₃. Eutectic compositions are indicated (E) and the Solar Salt (SS). Reference: O. Benes, R J M Konings, S. Wurzer, M. Sierig, A. Dockendorf. “A DSC study of the NaNO₃—KNO₃ system using an innovative encapsulation technique ” Thermochimica Acta 509 (2010) 62-66.

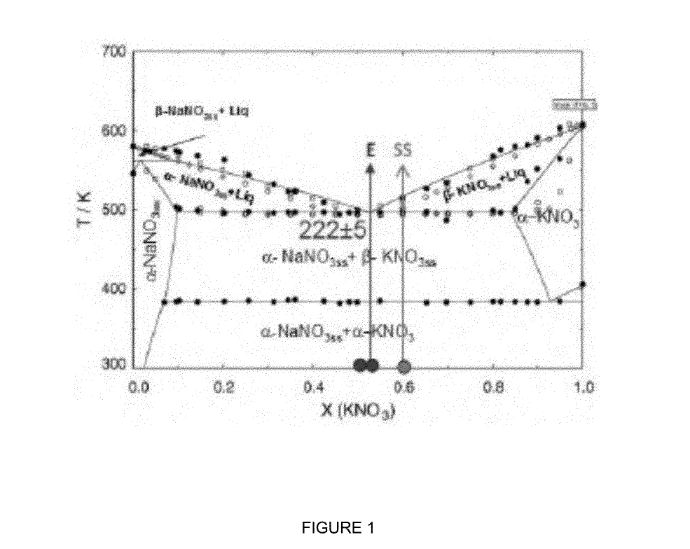

FIG. 2 shows Ternary System KNO₃—NaNO₃—Sr(NO₃)₂: to) isopletal Section, at 10% by weight of Sr(NO₃)₂ where the influence can be seen of the composition at the temperature of fusion of ternary mixtures; b) Isopletal Section between the binary eutectic NaNO₃—KNO₃ and the Sr(NO₃)₂ where the influence of strontium on the fusions temperature of ternary mixtures can be observed.

FIG. 3 shows liquidus surface of the ternary eutectic system Sr(NO₃)₂—NaNO₃—KNO₃.

FIG. 4 shows thermal Conductivity of the Solar Salt (SS) and the solar salt with strontium nitrate (TSS) in the range of temperatures from 60° C. to 280° C.

FIG. 5 shows variation of the viscosity with the temperature for the binary and ternary salts in the range of temperatures from 250 to 400° C.

FIG. 6 shows variation of specific heat in binary (SS) and ternary eutectic compositions with strontium nitrate (TSS) experimentally determined by differential calorimetry.

FIG. 7 shows microanalysis by SEM of the stainless steel-ternary salt interface after 5000 hours in contact with the ternary salt with strontium nitrate (TSS) at 565° C.

FIG. 8 shows: a) DTA curve of the eutectic composition of the binary system, 54% KNO₃: 46% NaNO₃ molar, showing the behavior at fusion during 4 consecutive warm-ups with intermediate cooling; b) Detail of the DTA during the cooling of the compositions 50% KNO³-50% NaNO₃ and 54% KNO₃-46% NaNO₃ molar.

FIG. 9 shows detail of the DTA curve of the eutectic composition of the binary system Sr(NO₃)₂—KNO₃ (26%: 74% molar) in which the typical behavior can be observed during the cooling of an eutectic composition.

FIG. 10 shows DTA of the eutectic composition of the binary system Sr(NO₃)₂—NaNO₃ (20%: 80% molar) where the typical behavior can be seen of an eutectic fusion. The first endothermic peak at 273° C. corresponds to the polymorphic transformation of NaNO₃.

FIG. 11 shows detail of the DTA curve of the ternary eutectic mix during the second heating-cooling cycle from room temperature to 350° C. showing: a) the endothermic peak corresponding to the eutectic fusion with a maximum temperature of 207° C. and b) the exothermic peak corresponding to the crystallization during the cooling that starts at 202.5° C.

FIG. 12 shows the DTA curve of a composition far from the eutectic point of the ternary system Sr(NO₃)₂—NaNO₃—KNO₃.

### DETAILED DESCRIPTION

To overcome the problems and needs of the state of the technique, the authors of the present invention, after carrying out an important research, project have developed a fluid able to maintain its liquid state for a more prolonged time and at a lower temperature than the existing formulas in the market, without the need for external heat input and insuring furthermore the stability of it at higher temperatures.

This new formulation is based on a ternary mixture of salts, based on Nitrates, including Strontium nitrate in their composition. This formulation of salts has direct application as heat storage fluid and as a heat transfer vehicle, being used as an application for systems of accumulation and transmission of heat in solar thermal power plants, just as in any other application where temporary energy storage is required and its subsequent transfer.

Thus, in a principal realization of the invention, a composition is considered that is comprised of a ternary mixture of nitrate salts, one of the components being Strontium Nitrate and the other two, alkali nitrate salts.

These new salt formulations present a low point of fusion and a high decomposition temperature.

The invention's composition uses formulations such as those represented in table 1, consisting of mixtures of salts of Strontium Nitrate and alkaline Nitrates such as Sodium and Potassium.

In Table 1 you can see the temperature of fusion of different binary and ternary alkali nitrates compositions (KNO₃ and NaNO₃) and Strontium Nitrate, determined experimentally by Differential Thermal Analysis and by the polythermic method A sub-cooling phenomenon has been found in compositions with Strontium during cooling (marked with * in table 1). The values are indicated which have been obtained from “Phase Diagrams for Ceramists” published by the “American Ceramic Society/NIST ” available.

TABLE 1

| | Composition mol %) | | | Experimental fusion range (±5° C.) | | |
|---|---|---|---|---|---|---|
| System/Heat rate | Sr(NO₃)₂ | NaNO₃ | KNO₃ | Solidus | Liquidus | Bibliography |
| Composition A (3° C./min) | 16.10 | 40.29 | 43.59 | 209/203* | 340 | |
| Composition F (3° C./min) | 9.1 | 45.7 | 45.19 | 208/204* | 260 | |
| Composition Z (3° C./min) | 4.70 | 42.94 | 52.35 | 209/203* | 210 | — |
| Eutectic KNO₃—NaNO₃ (3° C./min) | 0 | 47 | 53 | 219 | | 222 |
| Eutectic KNO₃—Sr(NO₃)₂ (3° C./min) | 26 | 74 | 0 | 217 | | 276 |
| Eutectic NaNO₃—Sr(NO₃)₂ | 23 | 77 | 0 | n.d. | | 294.6 |
| Eutectic Sr(NO₃)₂—KNO₃—NaNO₃ | 4.69 | 43.24 | 52.07 | 208/203* | 208 | n.d. |
| KNO₃ (1° C./min) | 0 | 0 | 100 | 327 | | 333.8 |
| NaNO₃ (1° C./min) | 0 | 100 | 0 | 291 | | 306.6 |
| Sr(NO₃)₂ (10° C./min) decomposes at | 100 | 0 | 0 | 600° C. | | 645 |
| T > 600° C.) | | | | | | |

In Table 1 you can see the temperature of fusion of different binary and ternary alkali nitrates compositions (KNO₃ and NaNO₃) and Strontium Nitrate, determined experimentally by Differential Thermal Analysis and by the polythermic method A sub-cooling phenomenon has been found in compositions with Strontium during cooling (marked with * in table 1). The values are indicated which have been obtained from “Phase Diagrams for Ceramists” published by the “American Ceramic Society/NIST ” available.

In one particular realization, at least one of the alkali nitrate salts present in the composition is selected from Sodium Nitrate and Potassium Nitrate. In a preferential way, the composition of the invention comprises a mixture of Strontium Nitrate, Potassium Nitrate and Sodium Nitrate. Preferably, Strontium Nitrate constitutes 5-50% by weight and the alkali nitrate salts 95-50% with regards to the weight of the composition.

In a preferred realization, this ternary mixture of nitrate salts is a eutectic mix whose point of fusion is less than 210° C. and whose decomposition occurs at a temperature higher than 500° C.

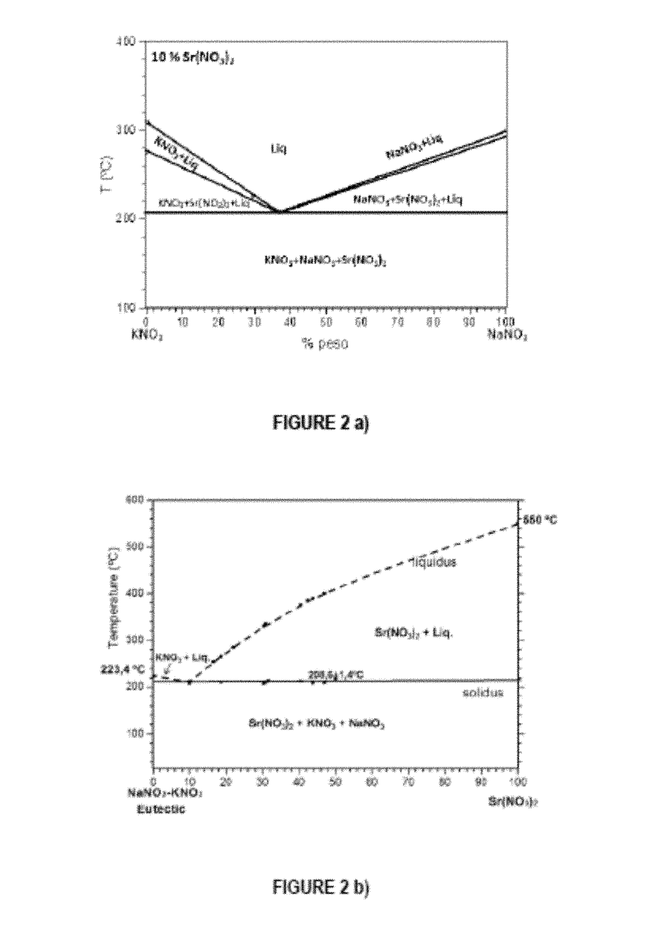

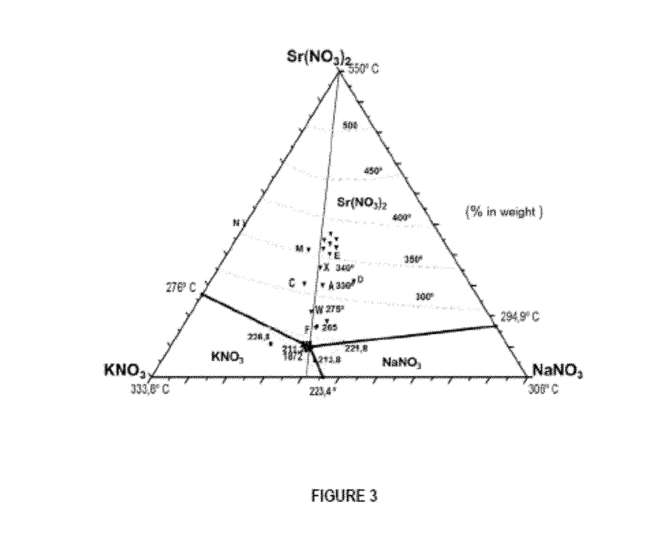

The eutectic composition is situated at 10%: 53%: 37% by weight of the Strontium, Potassium and Sodium Nitrates respectively. In FIGS. 2 and 3 it is observed that the temperature of fusion of this eutectic is 208±1.4° C.

Additionally, in this invention other non eutectic compositions are contemplated in order to adjust its point of fusion to various applications if deemed necessary. On the other hand, these ternary formulations can be more competitive from an economic point of view more so than the formulations currently on the market, because the price of Strontium Nitrate is much lower than that of Potassium Nitrate. Among them, a ternary composition has been chosen with representative strontium nitrate, called TSS, to show the physicochemical properties. This composition ranges from 5-20% of Sr(NO₃)2, 20-50% of KNO₃ and 40-70% NaNO₃, in % of weight.

The ternary compositions contemplated in this invention are not only of interest for their minimum point of fusion, but also because certain compositions present in the primary fields of crystallization of sodium nitrate and strontium nitrate have better physicochemical properties, so that by slightly increasing the point of fusion its behavior can be sensibly improved.

The characteristics of this formulation of salts outperform the binary combinations of salts currently marketed for their physicochemical properties, their high stability to high temperatures (higher than 500° C.) and most importantly, their lower point of fusion and their lower cost for the already mentioned lower cost of Sr(NO₃)2 compared to KNO₃. Therefore, the facilities operating with this formulation as a storage salt can work at a temperature which is more elevated in the Rankine cycle, so its efficiency would be higher. There are fewer problems of crystallization, being able to consider how the lower working temperature limit which is close to 215° C. (which expands the range of work. This allows to improve the operability of the solar thermal plants and reduce energy expenses during periods of no external heat input, besides being able to be used during longer periods of time for the same storage.

These properties together with those of high temperature stability, low corrosivity in the working temperature range studied for pure, low components low steam pressure, high thermal conductivity and high calorific capacity that characterizes the compositions of the invention, such as the low viscosity at high temperatures, they make this formulation suitable for use as a thermal storage fluid.

Another important property of the formulations presented in this invention is the absence of hydrates, so the handling of the solid salts, as well as with the liquid form does not present problems upon coming into contact with the environment. However, other formulations, for example with Calcic or Magnesium Nitrate, which form hydrates in contact with ambient humidity, present multiple problems during phase changes, not only in changes of state, but as well with the changes between different hydrated states.

All these properties, which characterize the compositions of the invention, allow their direct application as heat storage fluid and as a heat transfer vehicle, being used as an application for systems of accumulation and transmission of heat in solar thermal power plants, just as in any other application where temporary energy storage is required and its subsequent transfer.

Therefore, another main aspect of the invention the composition is considered of the invention for its use in the storage and for the transfer or transport of thermal energy. In particular, its application in the systems of accumulation and transmission of heat in solar thermal power plants, just as in any other application where temporary thermal energy storage is required and its subsequent transfer.

### EXAMPLES

Given the novelty of the invention's compositions, experimental data did not exist for ternary mixtures of the contemplated nitrate salts, for which became necessary the development of new compositions and the characterization of the properties of interest from the aforementioned formulations.

The experimentation for the development of the formulations for this invention's purpose were made in collaboration with the Institute of Ceramics and Glass of the CSIC (Spanish National Research Council). The determination of some of the physicochemical properties of the formulations was also realized at the Institute of Ceramics and Glass, like the Temperature of fusion, Calorific Capacity, and the Density.

The methodology applied for the search of the eutectic mix of each of the formulations is described below.

The tested compositions were prepared by the direct mixing of the different nitrates and to minimize the errors of composition such as possible contaminations, it was homogenized by fusion in a Pt. crucible. The nitrates used had a very high purity as proven in the determination of their fusion points.

To establish the ternary system they were determined experimentally, using the polythermic method and DTA, two isopletal sections to said system: one of them with a content of Sr(NO₃)₂ constant of 10% by weight and another in which it has remained constant the relation of KNO₃/NaNO₃ and the content of Sr(NO₃)₂ (FIG. 2). In FIG. 3, the surface of the liquidus of the ternary system Sr(NO₃)₂—NaNO₃—KNO₃ is represented as established. The thick continuous lines separate the different primary fields of crystallization (Sr(NO₃)₂, NaNO₃ and KNO₃) and correspond to lines in which two solid phases coexist and a liquid, the intersection of three lines define the composition of the eutectic ternary (in which at 210° C. the three solid phases coexist and a liquid). The intersection of each of the lines with the edges of the ternary system defines the three eutectic binaries (Sr (NO₃)₂—NaNO₃; Sr(NO₃)₂—NaNO₃ and KNO₃—NaNO₃). The isotherms are represented through discontinuous lines. The triangular points correspond to the different studied compositions, some of them included in Table 1, to define the system in a more comprehensive manner.

### Physicochemical Properties

The physicochemical properties of the ternary mixtures contemplated in this invention are very similar to those of Commercial Solar Salt (60% by weight of NaNO₃ and 40% by weight of KNO₃).

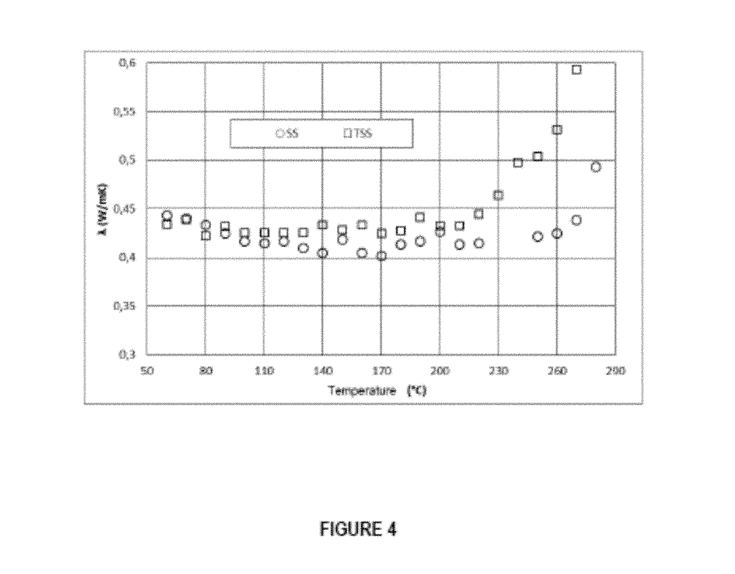

The thermal conductivities of the commercial Solar Salt (SS) and the ternary salt with Strontium (TSS) are shown in FIG. 4, where it can be seen that the difference between both is minimal at low temperatures, but at higher temperatures (major area of interest) the composition TSS has a higher thermal conductivity.

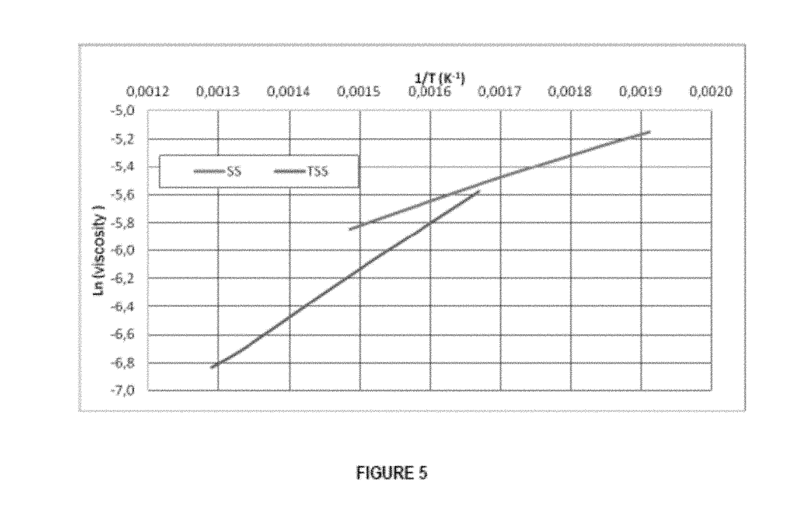

The variation of the viscosity with the temperature for the solar salt (SS) and ternary with Strontium (TSS) is represented in FIG. 5. The viscosity of the SS composition is found between 6-3 mPa·s for a temperature range of 250-400° C., while the ternary compositions with strontium nitrate are placed around 2 mPa·s for the same temperature range, indicating significantly less viscous behavior with respect to the SS.

In the case of density, ternary compositions with strontium nitrate turn out to be slightly more dense than solar salt, between 2 and 5% higher.

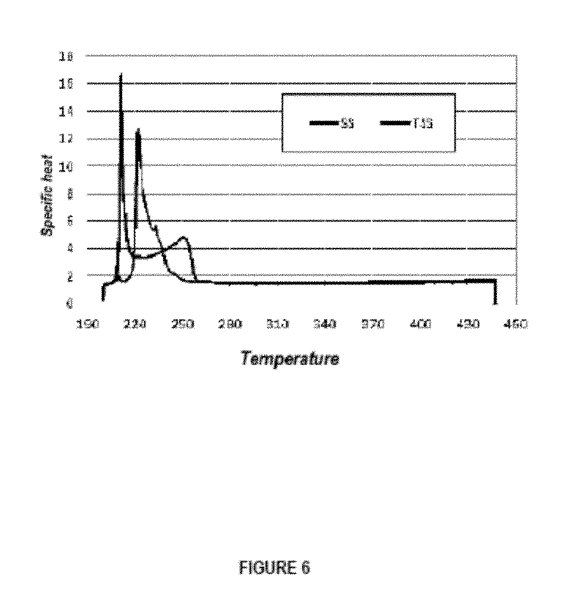

In FIG. 6 the Specific Heat is observed of the ternary mixture with strontium (TSS) compared with commercial solar salt (SS). An equivalent behavior between one and another salt can be seen so it will be able to be used for the same applications.

Stability against high temperatures has been experienced while maintaining the formulations during a 15 hour cooling period, then reheating them during a new period of maintenance of 15 hours at different temperatures (400° C., 450° and 500° C.), observing just a minimal loss of weight: <1% by weight in the early stages. This is justified by the presence of minimal impurities in the salts that form the mixture. When these impurities disappear, the formulation does not undergo changes in weight, both when raising and decreasing the temperature. Thus, advantageously, the invention's composition does not undergo decompositions or chemical changes in temperatures below 550° C.

The behavior with regards to corrosion at a high temperature of the ternary salt with strontium (TSS) is similar to that of commercial solar salt (SS). A series of commercial steels, carbon and stainless steels, have been tested, and other non-ferrous alloys, observing a mechanism of corrosion which is the same for all salts studied including solar commercial salt. In the interface molten salt steel are favored layer formations of protective spinels with some peel losses by descaling similar to those of commercial solar salt with corrosion rates of the same order of magnitude for the steels of greatest interest.

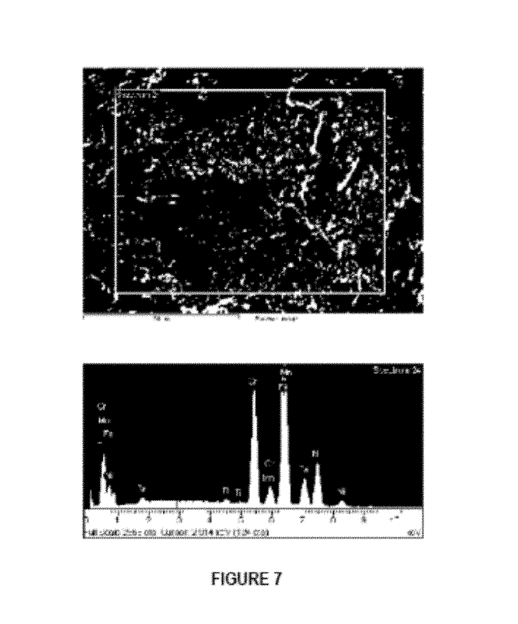

In FIG. 7 you can see the microanalysis by dispersion of energies from the ternary salt fused-steel interface in a Scanning Electron Microscope (SEM) to one of the attacked samples, in a sealed oven in an air atmosphere, during a period of 5000 hours at 565° C.

As can be observed, continuous protective layers are produced, generally thicker than those formed by commercial solar salt, avoiding preferential attacks on grain edge more frequent in thinner layers.

### Fusion Tests

Studies of fusion have been made using differential thermal analysis equipment and thermogravimetric (DTA-TG) at heating and cooling speeds that have varied according to the cases between 1, 2 and 3° C./min. In order to homogenize the sample, three consecutive heating and cooling cycles have been carried out in each of the samples. The first cycle has been used to achieve a perfect mixture of precursors, the results of this sequence have not been taken into account. The data of the other two cycles have been used to establish the fusion temperature.

The behavior to fusion of pure nitrates and well-known eutectic binaries has been established to validate the DTA as a method of adequate measurement. In Table 1 the results of three of the different analyzed compositions (B, G and H) are shown, in addition to the results of the eutectic binaries of interest obtained from Phase Diagrams for Ceramists published by American Ceramic Society/NIST.

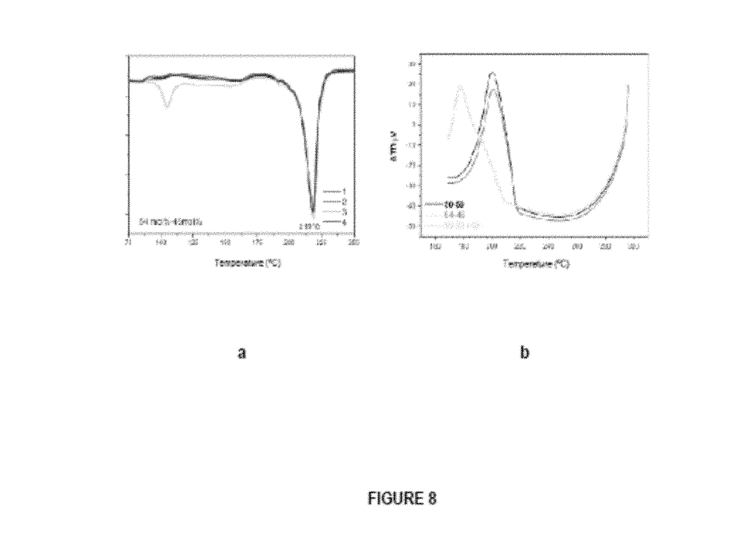

FIG. 8a shows the DTA of the eutectic of the KNO₃ binary system —NaNO₃, during 4 consecutive heating-cooling cycles (1, 2, 3 and 4), in the curve one observes that the endothermic peak corresponding to the fusion presents the maximum at the same temperature during the four cycles which indicates a great stability for the composition and reproducibility in the method of measurement. FIG. 8b shows the section of the DTA of the compositions 50% KNO₃-50% NaNO₃ and 54% KNO₃-46% NaNO₃ molar corresponding to the DTA cooling, in it the beginning of the exothermic peak is observed at 219° C., associated with eutectic crystallization. You can observe the similarity of the behavior of both compositions during solidification. The temperature of the eutectic coincides with the measurement error that has been established by other authors 222±5° C. for this invariant point.

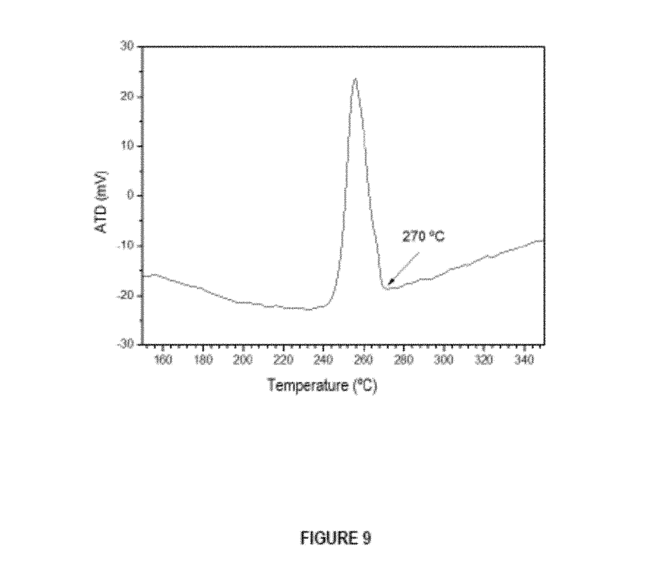

The behavior at fusion of the eutectic of the binary system Sr (NO₃)₂—KNO₃ (26 mol %: 74 mol %) is presented in FIG. 9. The exothermic peak registered during crystallization in cooling to 2° begins at 270° C., this temperature matches that of the eutectic determined by other authors.

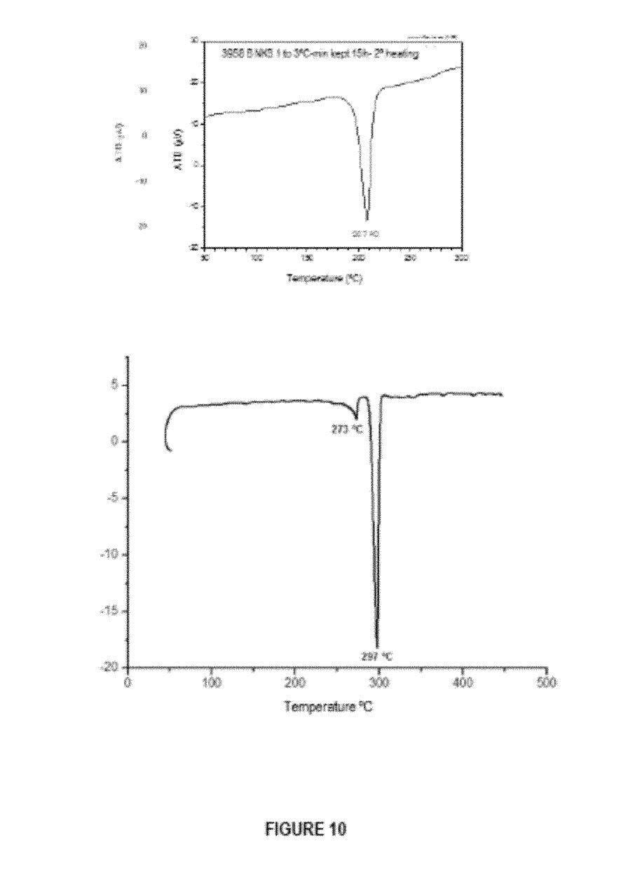

The behavior at the fusion of the eutectic of the binary system Sr(NO₃)₂—NaNO₃ (20 mol %: 80 mol %) is presented in FIG. 10. The exothermic peak registered during crystallization in the 2nd cooling starts at 297° C., this temperature matches that of the eutectic determined by other authors (294° C.).

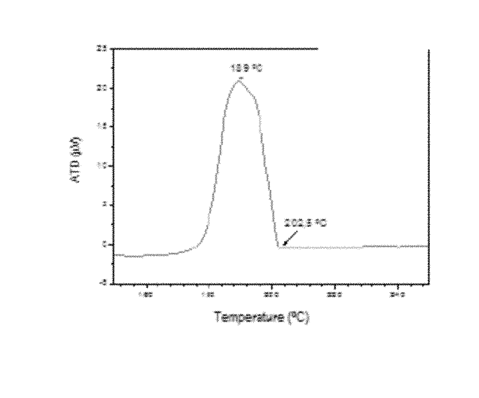

In FIG. 11 the behavior upon fusion of the eutectic of the ternary system Sr(NO₃)₂—NaNO₃—KNO₃. It can be seen that the temperature of fusion during the heating is 207° C. and during cooling 202.5° C. These differences between heating and cooling are due to the phenomena of subcooling. It can be observed compared to those corresponding to the SS; the lower point of crystallization of the formulations of this invention that would protect against the non-desired crystallization of the equipment, in turn increasing the range of work.

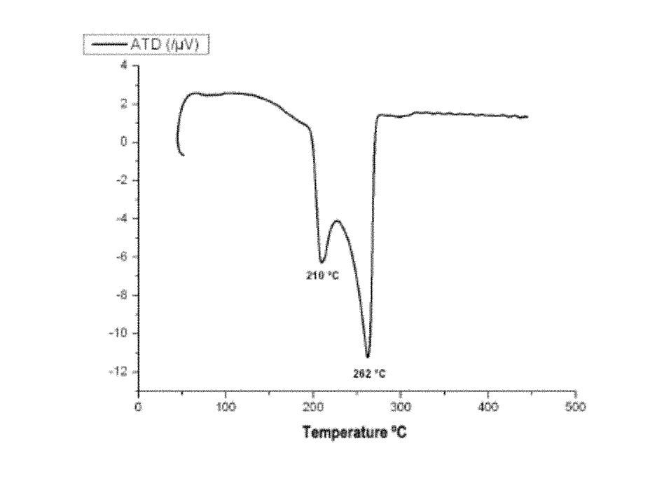

FIG. 12 shows the behavior at the fusion of a composition far from eutectic of the ternary system Sr(NO₃)₂—NaNO₃—KNO₃, the DTA presents a first peak to 210° C. which corresponds to the beginning of the (eutectic) fusion and a second peak to 262° C. that indicates the temperature of liquidus to us in this composition. This temperature of total fusion is slightly higher at (262° C.) than the value from the commercial solar salt (≈260° C.).

1. Composition comprising a ternary mixture of nitrate salts being one of the components Strontium Nitrate and the other two, alkali nitrate salts.

2. Composition according to claim 1 wherein at least one of the alkali nitrate salts present in the composition is selected from Sodium Nitrate and Potassium Nitrate.

3. Composition according to claim 2 comprising Strontium Nitrate, Sodium Nitrate and Potassium Nitrate.

4. Composition, according to claim 3, wherein the composition is eutectic.

5. Composition according to claim 4, where the Strontium Nitrate constitutes from 5 to 50% and the sum of alkali nitrate salts from 50 to 95% by weight of the composition.

6. Composition according to claim 5 wherein the percentages by weight of Strontium Nitrate, Potassium Nitrate and Sodium Nitrate, is situated at 10% -53% -37% by weight.

7. Use of a composition, according to claim 1, in the storage and transfer of thermal energy.

8. Use, according to claim 7, where the thermal energy is thermal solar.

9. Use of a composition, according to claim 2, in the storage and transfer of thermal energy.

10. Use, according to claim 9, where the thermal energy is thermal solar.

11. Use of a composition, according to claim 3, in the storage and transfer of thermal energy.

12. Use, according to claim 11, where the thermal energy is thermal solar.

13. Use of a composition, according to claim 4, in the storage and transfer of thermal energy.

14. Use, according to claim 13, where the thermal energy is thermal solar.

15. Use of a composition, according to claim 5, in the storage and transfer of thermal energy.

16. Use, according to claim 15, where the thermal energy is thermal solar.

17. Use of a composition, according to claim 6, in the storage and transfer of thermal energy.

18. Use, according to claim 17, where the thermal energy is thermal solar.
